(19) United States
(12) Patent Application Publication
(10) Pub. No.: US 2009/0024292 A1
(43) Pub. Date: Jan. 22, 2009

(54) Vehicle controller and control method

(75) Inventors: Seiji Kuwahara, Toyota-shi (JP); Masayuki Baba, Toyota-shi (JP)

Correspondence Address: OLIFF & BERRIDGE, PLC, P.O. BOX 320850, ALEXANDRIA, VA, 22320-4850, US

(73) Assignee: TOYOTA JIDOSHA KABUSHIKI KAISHA, TOYOTA-SHI (JP)

(21) Appl. No.: 12/216,493

(22) Filed: Jul. 7, 2008

(30) Foreign Application Priority Data
Jul. 18, 2007 (JP) 2007-186548

(51) Int. Cl. G06F 19/00

(52) U.S. Cl. 701/70

(57) ABSTRACT

An ECU executes a program including the steps of: detecting an accelerator position based on a signal transmitted from an accelerator position sensor 8010; calculating current driving force actually output from a vehicle; estimating a driving force expected by the driver, in accordance with the accelerator position and the current driving force actually output from the vehicle; determining a target throttle opening position so that difference between the driving force expected by the driver and the current driving force actually output by the vehicle becomes smaller, and controlling an electronic valve 8016.

This nonprovisional application is based on Japanese Patent Application No. 2007-186548 filed with the Japan Patent Office on Jul. 18, 2007, the entire contents of which are hereby incorporated by reference.

### BACKGROUND OF THE INVENTION

1. Field of the Invention

The present invention relates to a vehicle controller and control method and, more specifically, to a technique for controlling vehicle driving force.

2. Description of the Background Art

Conventionally, a vehicle driving source and an automatic transmission have been known, which are controlled such that a driving force in accordance with an operation of acceleration pedal (accelerator position) is output. For instance, an engine is regulated to realize a target throttle opening position determined in accordance with the amount of operation of the accelerator pedal. Further, the automatic transmission is regulated to achieve a determined gear in accordance with the amount of operation of the accelerator pedal.

Because of delayed response of engine operation in the intake system and delayed response in driving force transmitting system, the actual driving force follows the accelerator pedal operation with a delay. In a vehicle in which the engine and the automatic transmission are linked with a torque converter interposed, the torque may possibly increase delayed from the accelerator pedal operation, because of a torque amplifying function by the torque converter. In such situations, the driver possibly determines that the driving force is insufficient at the time he/she steps on the accelerator pedal and he/she may step on the accelerator pedal more than necessary. In that case, the driving force would eventually be excessively large. Thus, driving force different from that expected by the driver is output. In view of the foregoing, a technique has been proposed for controlling the driving force of the vehicle by calculating the driving force expected by the driver.

Japanese Patent Laying-Open No. 02-138561 discloses a control device for an automatic transmission in which driving force expected by the driver is calculated from throttle opening position, driving force actually output by the vehicle is calculated from the throttle opening position and engine speed, and the gear is changed in accordance with the ratio between the driving force expected by the driver and the driving force actually output by the vehicle.

The driver operates the accelerator pedal (throttle valve) so as to balance excess and deficiency of actual driving force with respect to the expected driving force. Therefore, even if the accelerator position (throttle opening position) is the same, expected driving force may differ. In the control device described in Japanese Patent Laying-Open No. 02-138561, the driving force actually output by the vehicle is not taken into account in calculating the driving force expected by the driver. Therefore, there is a margin of further improvement to attain the driving force expected by the driver.

### SUMMARY OF THE INVENTION

An object of the present invention is to provide a vehicle controller and a control method that can attain driving force reflecting the driving force expected by the driver with higher accuracy.

According to an aspect, the vehicle controller includes a sensor detecting an amount of operation of an accelerator pedal, and a control unit. The control unit calculates a first driving force output from the vehicle, estimates a second driving force expected by a driver in accordance with the first driving force and the amount of operation of the accelerator pedal, and controls the driving force of the vehicle in accordance with the second driving force.

In this arrangement, the amount of operation of accelerator pedal (accelerator position) is detected. Further, the first driving force output from the vehicle is calculated. The driver operates the accelerator pedal to balance excess and deficiency between the expected driving force and the actual driving force. Therefore, the driving force expected by the driver is supposed to reflect the amount of operation of the accelerator pedal on the driving force actually output by the vehicle. Therefore, in accordance with the first driving force as the driving force actually output by the vehicle and the amount of operation of accelerator pedal, a second driving force expected by the driver is estimated. Thus, the driving force expected by the driver can be estimated with higher accuracy. The driving force of the vehicle is controlled in accordance with the second driving force estimated to be the driving force expected by the driver. For example, the vehicle driving power is regulated such that the difference between the second driving force expected by the driver and the first driving force output by the vehicle becomes smaller. Consequently, the driving force better reflecting the driving force expected by the driver can be attained.

Preferably, the control unit controls the driving force of the vehicle such that difference between the second driving force and the first driving force becomes smaller.

In this arrangement, the vehicle driving force is regulated such that the difference between the second driving force expected by the driver and the first driving force output by the vehicle becomes smaller. Consequently, the driving force better reflecting the driving force expected by the driver can be attained.

More preferably, the control unit estimates the second driving force, by back-calculating a predetermined operation to obtain the amount of operation of the accelerator pedal corresponding to the difference between the second driving force and the first driving force, using the first driving force and the amount of operation of the accelerator pedal.

In this arrangement, the result of feeding back the actual driving force to the expected driving force is output by the driver as the amount of operation of accelerator pedal. Therefore, it becomes possible to define in advance a calculation to find the amount of operation of the accelerator pedal that corresponds to the difference between the second driving force expected by the driver and the first driving force output by the vehicle. For example, a calculation to fined the amount of operation of the accelerator pedal is defined in advance through experiments, simulations or the like. By back-calculation using the first driving force and the amount of operation of accelerator pedal, the second driving force can be estimated. Thus, the driving force expected by the driver can be estimated with higher accuracy.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic view showing a structure of a vehicle.

FIG. 2 is a functional block diagram of an ECU.

FIG. 3 is a (first) graph representing the driving force expected by the driver, actually output driving force and accelerator position.

FIG. 4 shows a model of thinking by the driver.

FIG. 5 shows a model for estimating the driving force expected by the driver.

FIG. 6 shows a model for determining a target value of throttle opening position.

FIG. 7 shows a control structure of a program executed by the ECU.

FIG. 8 is a (second) graph representing the driving force expected by the driver, actually output driving force and accelerator position.

FIG. 9 is a (third) graph representing the driving force expected by the driver, actually output driving force and accelerator position.

FIG. 10 is a (fourth) graph representing the driving force expected by the driver, actually output driving force and accelerator position.

### DESCRIPTION OF THE PREFERRED EMBODIMENTS

In the following, an embodiment of the present invention will be described with reference to the figures. In the following description, the same components are denoted by the same reference characters. Their names and functions are also the same. Therefore, detailed description thereof will not be repeated.

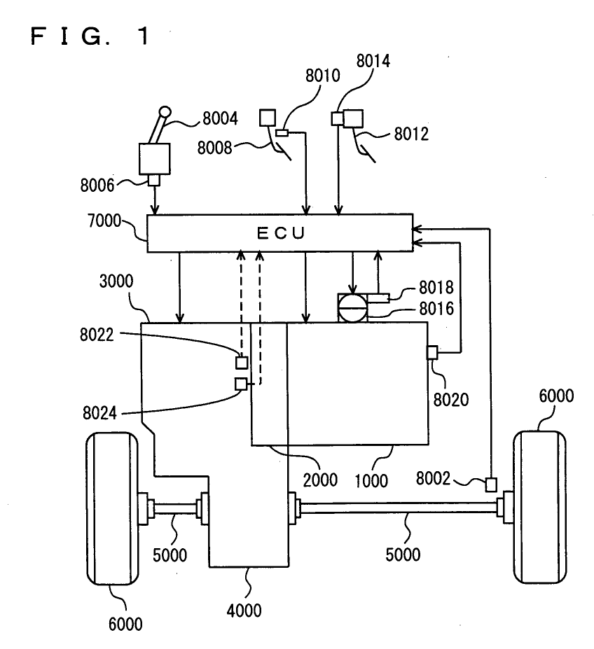

Referring to FIG. 1, the vehicle having the controller in accordance with an embodiment of the present invention will be described. The vehicle is an FF (Front engine Front drive) vehicle. It is noted that the vehicle may be a vehicle such as an FR (Front engine Rear drive) vehicle other than the FF vehicle.

The vehicle includes an engine 1000, a torque converter 2000, an automatic transmission 3000, a differential gear 4000, a drive shaft 5000, front wheels 6000 and an ECU (Electronic Control Unit) 7000.

Engine 1000 is an internal combustion engine that burns a mixture consisting of fuel injected from an injector (not shown) and air, inside a combustion chamber of a cylinder. A piston in the cylinder is pushed down by the combustion, whereby a crankshaft is rotated. An amount of fuel injected from the injector is determined in accordance with an amount of air taken into engine 1000 such that a desired air-fuel ratio (for example, stoichiometric air-fuel ratio) is attained. A motor may be used as a driving source, in place of the engine.

Automatic transmission 3000 is coupled to engine 1000 with torque converter 2000 being interposed. Therefore, an output shaft speed of torque converter 2000 (a turbine speed NT) is equal to an input shaft speed of automatic transmission 3000.

Automatic transmission 3000 has a planetary gear unit. Automatic transmission 3000 converts the rotation speed of the crankshaft to a desired speed by realizing a desired gear. Instead of the automatic transmission achieving the gear, a CVT (Continuously Variable Transmission) that continuously varies a gear ratio may be mounted. Alternatively, an automatic transmission including constant mesh gears shifted by means of a hydraulic actuator may be mounted.

An output gear of automatic transmission 3000 meshes with differential gear 4000. Drive shaft 5000 is coupled to differential gear 4000 by spline-fitting or the like. A motive power is transmitted to left and right front wheels 6000 via drive shaft 5000.

Wheel speed sensors 8002, a position sensor 8006 of a shift lever 8004, an accelerator pedal position sensor 8010 of an accelerator pedal 8008, a stroke sensor 8014 of a brake pedal 8012, a throttle opening position sensor 8018 of an electronic throttle valve 8016, an engine speed sensor 8020, an input shaft speed sensor 8022 and an output shaft speed sensor 8024 are connected to ECU 7000 via a harness and the like.

Wheel speed sensors 8002 detect the wheel speeds of the four wheels of the vehicle, respectively, and transmit signals representing the detected results to ECU 7000. The position of shift lever 8004 is detected by position sensor 8006, and a signal representing the detected result is transmitted to ECU 7000. A gear of automatic transmission 3000 is automatically selected corresponding to the position of shift lever 8004. Additionally, such a configuration may be employed that the driver can select a manual shift mode for arbitrarily selecting a gear according to the driver's operation.

Accelerator pedal position sensor 8010 detects the stepped amount (accelerator position) of accelerator pedal 8008 operated by the driver, and transmits a signal representing the detected result to ECU 7000. Stroke sensor 8014 detects the stroke amount of brake pedal 8012 operated by the driver, and transmits a signal representing the detected result to ECU 7000.

Throttle opening position sensor 8018 detects the degree of opening (throttle opening position) of electronic throttle valve 8016 of which position is adjusted by the actuator, and transmits a signal representing the detected result to ECU 7000. Electronic throttle valve 8016 regulates the amount of air (output of engine 1000) taken into engine 1000. The amount of air taken into engine 1000 increases as the throttle opening increases. Thus, the throttle opening position can be used as a value representing the output of engine 1000. The amount of air may be regulated by varying a lift amount or an angle of action of an intake valve (not shown) provided in the cylinder. Here, the amount of air increases as the lift amount and/or the angle of action increases.

Engine speed sensor 8020 detects the number of rotations (engine speed NE) of the output shaft (crankshaft) of engine 1000, and transmits a signal representing the detected result to ECU 7000. Input shaft speed sensor 8022 detects an input shaft speed NI (turbine speed NT) of automatic transmission 3000, and transmits a signal representing the detected result to ECU 7000.

Output shaft speed sensor 8024 detects an output shaft speed NO of automatic transmission 3000, and transmits a signal representing the detected result to ECU 7000. ECU 7000 detects the vehicle speed based on output shaft speed NO, a radius of the wheel and the like. The vehicle speed can be detected by a well-known technique, and therefore description thereof is not repeated. In place of the vehicle speed, output shaft speed NO may directly be used.

ECU 7000 controls equipment such that the vehicle attains a desired running state, based on signals sent from the foregoing sensors and the like as well as a map or a program stored in an ROM (Read Only Memory). ECU 7000 may be divided into a plurality of ECUs.

In the present embodiment, when shift lever 8004 is in a D (drive) position and thereby a D (drive) range is selected as the shift range in automatic transmission 3000, ECU 7000 regulates automatic transmission 3000 to achieve one of the first to sixth gears. Since one of the first to sixth gears is achieved, automatic transmission 3000 can transmit a driving force to front wheels 6000. It is noted that the number of gears is not limited to six, and may be seven or eight. The gear of automatic transmission 3000 is set in accordance with a shift map determined by using throttle opening position and vehicle speed. Accelerator position may be used in place of throttle opening position.

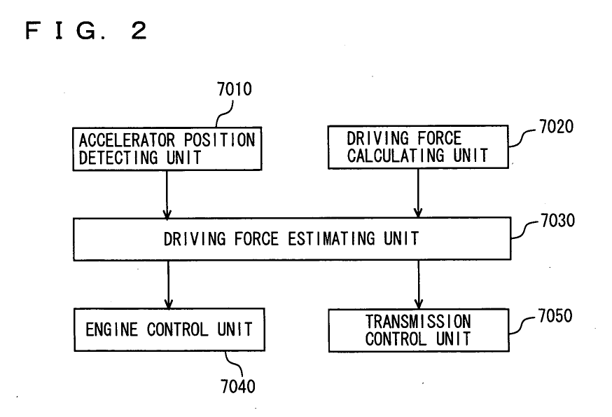

Referring to FIG. 2, the function of ECU 7000 will be described below. The following function of ECU 7000 may be implemented by either hardware or software.

ECU 7000 includes an accelerator position detecting unit 7010, a driving force calculating unit 7020, a driving force estimating unit 7030, an engine control unit 7040, and a transmission control unit 7050. Accelerator position detecting unit 7010 detects accelerator position based on a signal transmitted from an accelerator position sensor 8010.

Driving force calculating unit 7020 calculates the driving force actually output from the vehicle. The driving force actually output from the vehicles is, for example, calculated by using a vehicle model having, as parameters, an output torque of engine 1000, efficiency and torque ratio of torque converter 2000, gear ratio of automatic transmission 3000, gear ratio of differential gear 4000 and radius of wheels. The output torque of engine 1000 is calculated based on the accelerator position, engine speed NE, throttle opening position and the like. The driving force may be calculated additionally using acceleration of the vehicle, output toque of engine 1000 calculated from the intake amount of air, and the amount of operations of each of the actuators provided in the vehicle. As to the method of calculating the driving force actually output from the vehicle, well-known general technique may be applied and, therefore, detailed description thereof will not be repeated.

Driving force estimating unit 7030 estimates the driving force expected by the driver, in accordance with the accelerator position and the driving force actually output from the vehicle. In the following, the method of estimating the driving force expected by the driver will be described in detail.

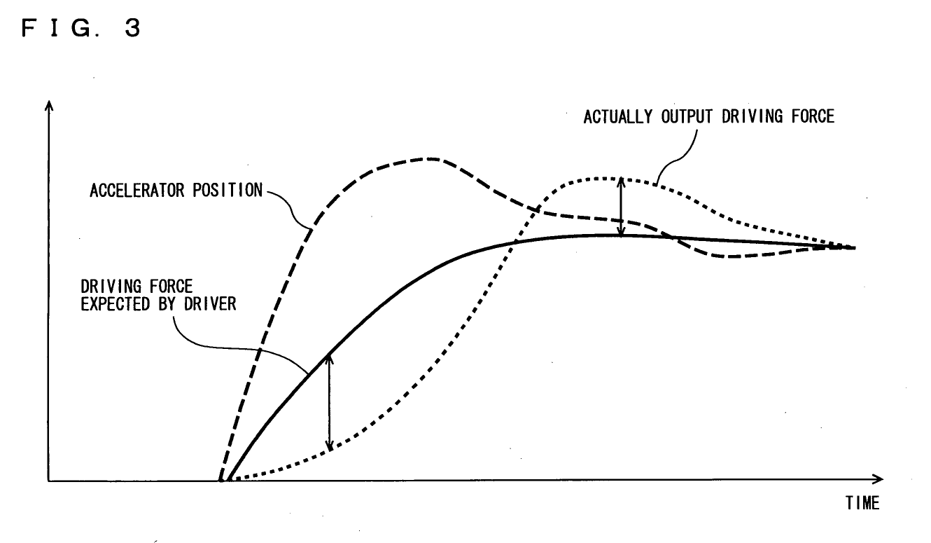

As shown in FIG. 3, the driver operates an accelerator pedal 8008 to strike a balance between excess and deficiency of the current driving force actually output from the vehicle from the expected driving force. By way of example, if the current driving force actually output from the vehicle is smaller than the expected driving force, accelerator pedal 8008 is operated to increase the accelerator position. If the current driving force actually output from the vehicle is larger than the expected driving force, accelerator pedal 8008 is operated to decrease the accelerator position. Therefore, it may be considered that the result of feeding-back the actual driving force to the expected driving force is output as the accelerator pedal position, by the driver.

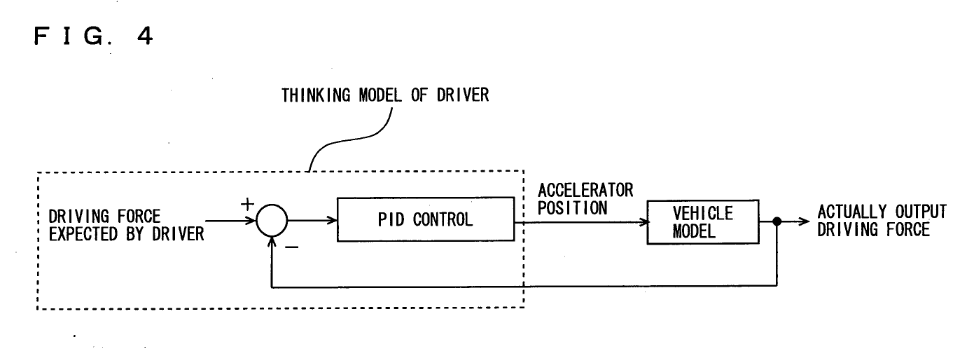

Therefore, the thinking of the driver can be modeled as shown in FIG. 4. In FIG. 4, the portion surrounded by the dotted line represents the thinking model of the driver. The driving force actually output from the vehicle is calculated using the vehicle model, as described above.

In the model shown in FIG. 4, it can be seen that the driver outputs the accelerator position by inputting the difference between the expected driving force and the current driving force actually output from the vehicle to PID (Proportional-plus-Integral-plus-Derivative) control.

Therefore, using the driving force expected by the driver, the accelerator position and the driving force output by the vehicle, an operation that is supposed to be done by the driver in PID control is determined in advance. The driving force expected by the driver is determined by a designer through an experiment, simulation or the like. For the accelerator position and the driving force output by the vehicle, values obtained through experiments, simulation or the like are used.

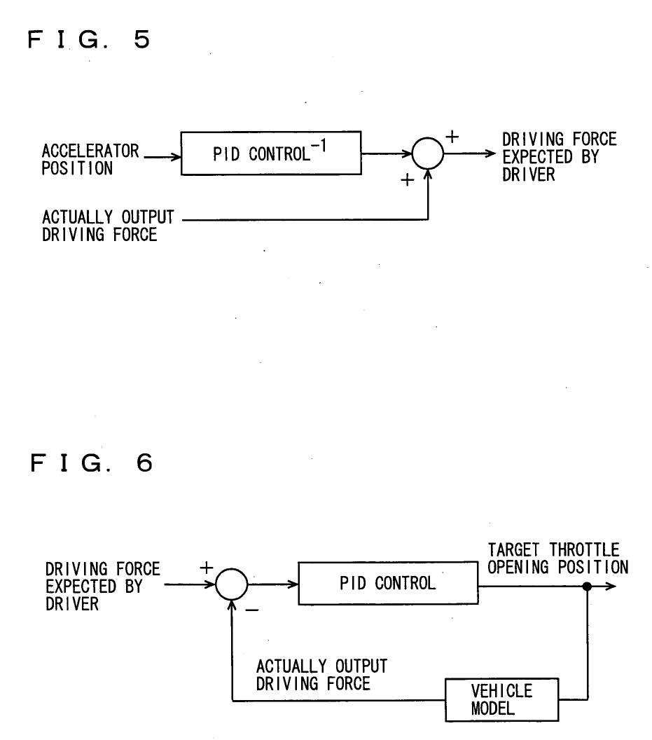

If the driving force expected by the driver is to be estimated during running of the vehicle, using the detected accelerator position and the driving force calculated as the driving force output from the vehicle, the predetermined operation is back-calculated, whereby the driving force expected by the driver is estimated (calculated), as shown in FIG. 5. Specifically, in the present embodiment, the driving force expected by the driver is estimated in accordance with the accelerator position and the current driving force output from the vehicle.

Engine control unit 7040 controls driving force of the vehicle such that the difference between the driving force expected by the driver and the driving force actually output from the vehicle becomes smaller. More specifically, a target value of throttle opening position is determined by PID control such that the difference between the driving force expected by the driver and the driving force actually output from the vehicle becomes smaller, as shown in FIG. 6.

By way of example, assume that the current driving force actually output from the vehicle is smaller than the expected driving force. In that case, a larger target value is set, as the difference (difference in absolute value) between the driving force expected by the driver and the driving force actually output by the vehicle is larger. If the current driving force actually output from the vehicle is larger than the expected driving force, a smaller target value is set, as the difference (difference in absolute value) between the driving force expected by the driver and the driving force actually output by the vehicle is larger. The target value of throttle opening position is set in consideration of dead time of engine 100 and driving force transmitting system, a response delay, and torque amplified by torque converter 2000. The method of setting throttle opening position is not limited thereto.

An electronic throttle valve 8016 is controlled such that the actual throttle opening position matches the target value. By the control of electronic throttle valve 8016, the output torque of engine 1000 is controlled. As a result, the driving force of the vehicle is controlled such that the difference between the driving force expected by the driver and the driving force actually output by the vehicle becomes smaller. In place of throttle opening position, the target value of amount of intake air, output torque, amount of fuel injection or the like may be determined.

Transmission control unit 7050 controls gear shift of automatic transmission 3000 using the driving force expected by the driver. More specifically, the driving force expected by the driver is converted to the throttle opening position used for determining necessity of gear shift, that is, the gear. For instance, the driving force expected by the driver is converted to the throttle opening position in accordance with a predetermined map. The throttle opening position may be different from the target value of throttle opening position calculated by engine control unit 7040.

Transmission control unit 7050 determines the gear in accordance with the shift map, using the throttle opening position obtained by converting the driving force expected by the driver. Automatic transmission 3000 is controlled so that the determined gear is achieved.

Rather than converting the driving force expected by the driver to the throttle opening position, the driving force may be converted to the accelerator position to determine the gear. Alternatively, the gear may be determined directly using the driving force expected by the driver.

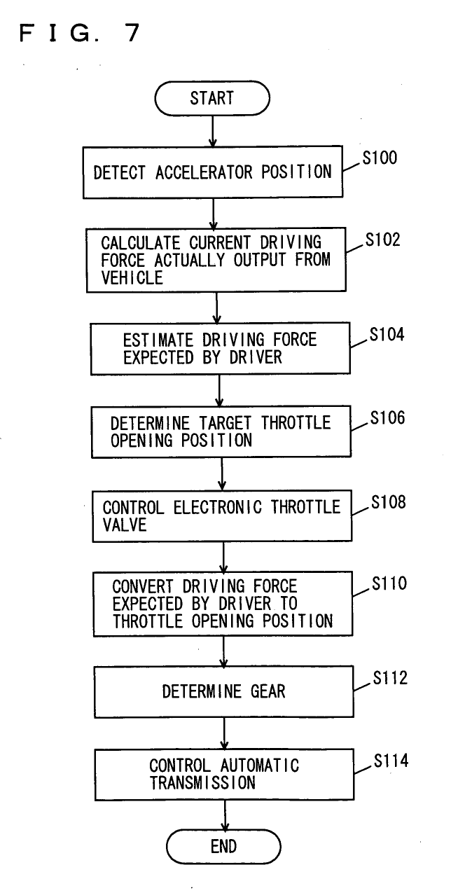

Referring to FIG. 7, the control structure of a program executed by ECU 7000 as the controller in accordance with the present embodiment will be described. The program described in the following is repeatedly executed in a predetermined period. Further, the program executed by ECU 7000 may be recorded on a recording medium such as a CD (Compact Disk) or a DVD (Digital Versatile Disk) and commercially distributed.

At step (hereinafter simply denoted by “S”) 100, ECU 7000 detects the accelerator position based on a signal transmitted from accelerator position sensor 8010. At S102, ECU 7000 calculates the current driving force actually output from the vehicle. At S104, ECU 7000 estimates the driving force expected by the driver, in accordance with the current driving force actually output by the vehicle and the accelerator position.

At S106, ECU 7000 determines the target throttle opening position such that the difference between the driving force expected by the driver and the current driving force actually output by the vehicle becomes smaller. At S108, ECU 7000 controls electronic throttle valve 8016 so that the actual throttle opening position attains to the target value.

At S110, at ECU 7000, the driving force expected by the driver is converted to the throttle opening position used for determining the gear. At S112, ECU 7000 determines the gear in accordance with the shift map, using the throttle opening position obtained by converting the driving force expected by the driver. At S114, ECU 7000 controls automatic transmission 3000 to realize the determined gear.

The operation of ECU 7000 based on the structure and flowchart as above will be described.

While the vehicle is running, the accelerator position is detected based on a signal transmitted from accelerator position sensor 8010 (S100). Further, the current driving force actually output from the vehicle is calculated (S102). In accordance with the current driving force actually output from the vehicle and the accelerator position, the driving force expected by the driver is estimated (S104).

The target throttle opening position is determined such that the difference between the driving force expected by the driver and the current driving force actually output by the vehicle becomes smaller (S106). Electronic throttle valve 8016 is controlled so that the actual throttle opening position attains to the target value (S108).

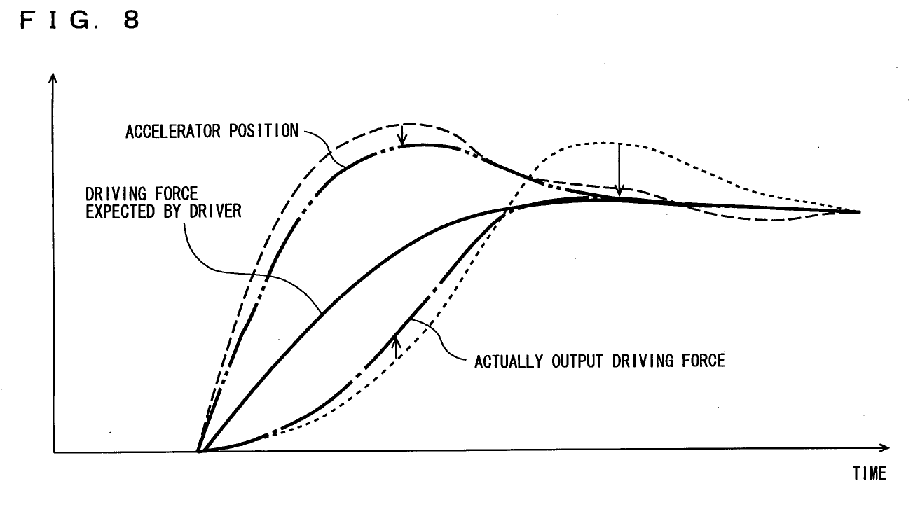

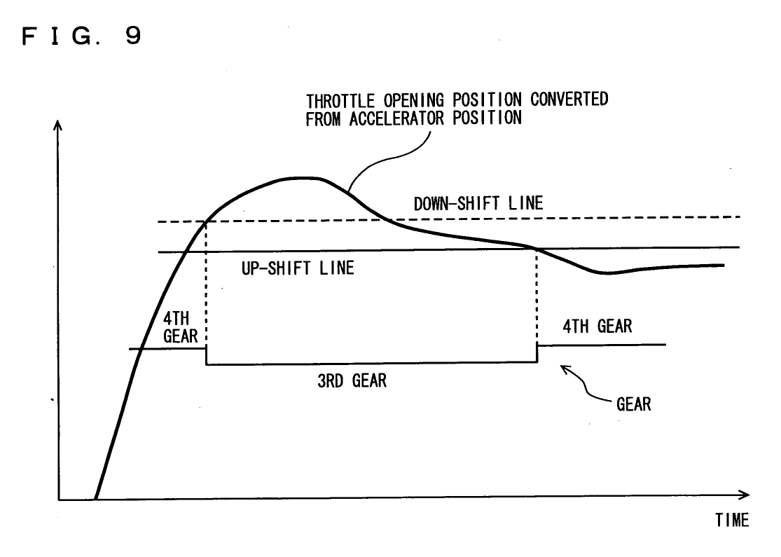

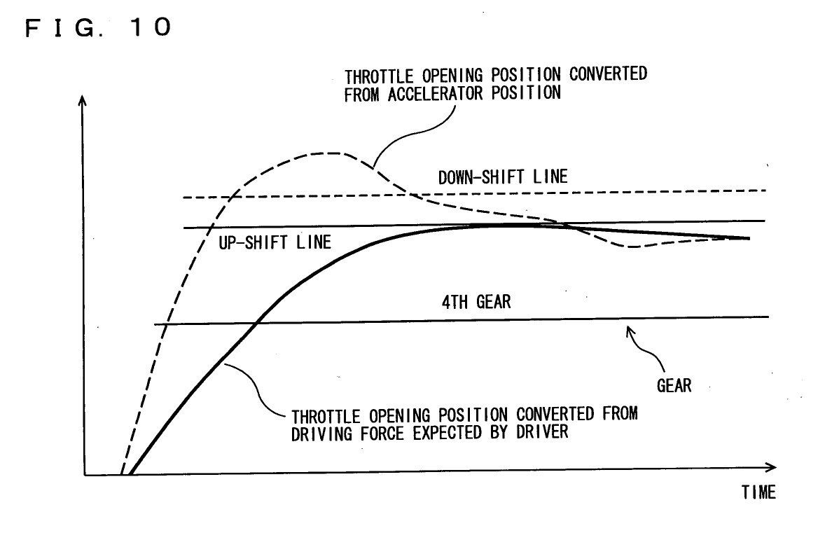

Consequently, the deficiency of actual driving force with respect to the driving force expected by the driver can be made smaller, as shown by chain-dotted line in FIG. 8. Therefore, as shown by a two-dotted line in FIG. 8, excessive amount of operation of accelerator pedal 8008 can be reduced. As a result, overshoot of driving force can be prevented, and the driving force expected by the driver can quickly be attained.

When the gear is determined, if the throttle opening position converted by accelerator position is used, accelerator pedal 8008 comes to be operated to compensate for the response delay of the driving force actually output from the vehicle and, therefore, there may possibly occur overshoot of throttle opening position. The overshoot of throttle opening position may lead to an unnecessary down-shift.

In view of the foregoing, in the present embodiment, the driving force expected by the driver is converted to the throttle opening position used for determining the gear (S110). Using the throttle opening position obtained by converting the driving force expected by the driver, the gear is determined in accordance with the shift map (S112). Automatic transmission 3000 is controlled to realize the determined gear (S114). Thus, the overshoot of throttle opening position used for determining the gear can be prevented, as shown in FIG. 10. Thus, the number of unnecessary down-shifts can be reduced.

As described above, according to the controller of the present invention, the driving force expected by the driver is estimated in accordance with the accelerator position and the current driving force actually output by the vehicle. The driver operates the accelerator pedal to adjust excess and deficiency of actual driving force to the expected driving force. Therefore, the driving force expected by the driver is considered to reflect the amount of operation of the accelerator pedal on the driving force actually output by the vehicle. Therefore, using the accelerator position and the current driving force actually output from the vehicle, the driving force expected by the driver can be estimated more accurately. The target throttle opening position is determined so that the difference between the driving force expected by the driver and the current driving force actually output by the vehicle becomes smaller. The electronic throttle valve is controlled so that the actual throttle opening position attains to the target value. Thus, driving force accurately reflecting the driving force expected by the driver can be realized.

In place of the driving force, torque or acceleration may be used.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A vehicle controller, comprising:
a sensor detecting an amount of operation of an accelerator pedal; and
a control unit;
said control unit
calculating a first driving force output from the vehicle,
estimating a second driving force expected by a driver in accordance with said first driving force and said amount of operation of the accelerator pedal, and
controlling the driving force of said vehicle in accordance with said second driving force.

2. The vehicle controller according to claim 1, wherein
said control unit controls the driving force of said vehicle such that difference between said second driving force and said first driving force becomes smaller.

3. The vehicle controller according to claim 1, wherein
said control unit estimates said second driving force, by back-calculating a predetermined operation to obtain the amount of operation of said accelerator pedal corresponding to the difference between said second driving force and said first driving force, using said first driving force and said amount of operation of said accelerator pedal.

4. A method of controlling a vehicle, comprising the steps of:
detecting an amount of operation of an accelerator pedal;
calculating a first driving force output from the vehicle;
estimating a second driving force expected by a driver, in accordance with said first driving force and said amount of operation of said accelerator pedal; and
controlling the driving force of said vehicle in accordance with the second driving force.

5. The method of controlling a vehicle according to claim 4, wherein
said step of controlling the driving force of said vehicle in accordance with the second driving force includes the step of controlling the driving force of said vehicle such that difference between said second driving force and said first driving force becomes smaller.

6. The method of controlling a vehicle according to claim 4, wherein
said step of controlling the driving force of said vehicle in accordance with the second driving force includes the step of estimating said second driving force, by back-calculating a predetermined operation to obtain the amount of operation of said accelerator pedal corresponding to the difference between said second driving force and said first driving force, using said first driving force and said amount of operation of said accelerator pedal.

7. A vehicle controller, comprising:
means for detecting an amount of operation of an accelerator pedal;
means for calculating a first driving force output by the vehicle;
estimating means for estimating a second driving force expected by a driver, in accordance with said first driving force and said amount of operation of said accelerator pedal; and
control means for controlling the driving force of said vehicle in accordance with said second driving force.

8. The vehicle controller according to claim 7, wherein
said control means includes means for controlling the driving force of said vehicle such that difference between said second driving force and said first driving force becomes smaller.

9. The vehicle controller according to claim 7, wherein
said estimating means includes means for estimating said second driving force, by back-calculating a predetermined operation to obtain the amount of operation of said accelerator pedal corresponding to the difference between said second driving force and said first driving force, using said first driving force and said amount of operation of said accelerator pedal.
